(19) United States
(12) Patent Application Publication
(10) Pub. No.: US 2025/0217011 A1
(43) Pub. Date: Jul. 3, 2025

(54) VIDEO CONFERENCE MANAGEMENT FOR A VIRTUAL WHITEBOARD GRAPHICAL USER INTERFACE

(71) Applicant: Atlassian Pty Ltd., Sydney (AU)

(72) Inventor: Cornelis Jacobus Alant, Sydney (AU)

(21) Appl. No.: 18/399,570

(22) Filed: Dec. 28, 2023

(51) Int. Cl. G06F 3/0484; G06F 3/04815; H04L 65/401

(52) U.S. Cl. CPC G06F 3/0484; G06F 3/04815; H04L 65/4015

(57) ABSTRACT

Embodiments include methods and systems for initiating multiple videoconference sessions using a virtual whiteboarding application. The methods can include causing display of a set of virtual whiteboard graphical user interfaces on multiple client devices, where each interface include a respective viewport of a virtual canvas. The methods can include determining a set of reference locations for a respective viewport within the virtual canvas. In response to determining that a subset of the set of reference locations satisfies a cluster criteria, causing display of a first prompt on a first client device associated with a first reference location of the first subset of the set of reference locations, the first prompt including a first invitation to participate in a first videoconference having a first set of participants.

### FIELD

The described embodiments relate to systems and methods providing a virtual whiteboard application having a virtual canvass to a group of users during a whiteboarding session. In particular, the present embodiments relate to methods and systems for displaying indications of videoconferences that relate to particular regions of a virtual canvas and automatically providing options to join and leave videoconferences based on interactions with the virtual canvas.

### BACKGROUND

Modern enterprises and collaboration platforms typically enable a group of users to collaborate with each other, for example, using electronic documents or other shared media. A virtual whiteboarding application may provide a virtual platform for groups of users to meet, brainstorm and collaborate on various ideas. Often times groups of user's may breakout into smaller groups to discuss specific topics. However, the virtual environment of many virtual whiteboarding applications can make it difficult to transition between different groups and/or topics being discussed in a virtual whiteboarding session.

### SUMMARY

Embodiments are directed to methods and systems for initiating multiple videoconference sessions using a virtual whiteboarding application. The methods can include causing display of a set of virtual whiteboard graphical user interfaces on multiple client devices, where each client device is associated with a respective user participating in a virtual whiteboarding session. Each virtual whiteboard graphical user interface can include a respective viewport to a virtual canvas, where the virtual canvas is configured to receive simultaneous user inputs from each of the multiple client devices. The methods can include determining a set of reference locations, where the set of reference locations comprising a reference location for each client device of the multiple client devices. Each reference location can indicate a location of the respective viewport within the virtual canvas, where the viewport can be displayed in the virtual whiteboard graphical user interface for a corresponding client device. In response to determining that a first subset of the set of reference locations satisfies a cluster criteria, the methods can include causing display of a first prompt on a first client device associated with a first reference location of the first subset of the set of reference locations. The first prompt can include a first invitation to participate a first videoconference having a first set of participants. In response to determining that a second subset of the set of reference locations satisfy the cluster criteria, causing display of a second prompt on a second client device associated with a second reference location of the second subset of the set of reference locations. The second prompt can include a second invitation to participate a second videoconference having a second set of participants different than the first set of participants.

Embodiments are further directed to methods and systems for managing videoconference sessions in a virtual whiteboarding application. The methods can include causing display of a virtual whiteboard graphical user interface on multiple client devices each associated with a different user participating in a whiteboarding session. The virtual whiteboard graphical user interface can include a virtual canvas configured to receive simultaneous inputs from the multiple client devices. The methods can include determining a reference location for a client device of the multiple client devices. The reference location can indicate a location of a viewport within the virtual canvas, where viewport can be displayed in the virtual whiteboard graphical user interface for the client device. In response to determining that the reference location satisfies a proximity criteria corresponding a region of the virtual canvas associated with a videoconference, the methods can include causing display of an option to join the videoconference on the client device. In response to receiving a selection of the option to join the videoconference, the methods can include causing the client device to display a videoconference interface for the videoconference in a first area of the whiteboard graphical user interface and the region of the virtual canvas in a second area of the graphical user interface.

Embodiments can also include a server system that can include a memory allocation defined by a data store storing one or more executable assets and a working memory allocation, and a processor allocation configured to load the one or more executable assets from the data store and into the working memory allocation to instantiate an instance of a client application on a client device. The one or more executable assets can be configured to cause display of a set of virtual whiteboard graphical user interfaces on multiple client devices, where each client device is associated with a respective user participating in a virtual whiteboarding session and each virtual whiteboard graphical user interface includes a respective viewport to a virtual canvas. The virtual canvas can be configured to receive simultaneous user inputs from each of the multiple client devices. The one or more executable assets can be configured to determine a set of reference locations, the set of reference locations comprising a reference location for each client device of the multiple client devices. Each reference location can indicate a location of the respective viewport within the virtual canvas, where the viewport being displayed in the virtual whiteboard graphical user interface for a corresponding client device. The one or more executable assets can be configured to cause display of a prompt on a first client device associated with a first reference location of the first subset of the set of reference locations in response to determining that a subset of the set of reference locations satisfy a cluster criteria. The first prompt can include a first invitation to participate in a first videoconference having a first set of participants.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 depicts a system for collaboration among a group of users in accordance with the embodiments described herein.

FIG. 2 depicts an example of a virtual whiteboard graphical user interface, in accordance with some embodiments.

FIGS. 3A-3B depict examples of a virtual canvas that is configured to receive inputs from multiple client devices and manage multiple videoconference sessions, in accordance with some embodiments.

FIG. 4 depicts an example of a virtual whiteboard graphical user interface that may be displayed on a client device, in accordance with some embodiments.

FIG. 5 depicts an example of a virtual whiteboard application that may be displayed on a client device, in accordance with some embodiments.

FIG. 6 depicts an example of a virtual canvas that is configured to receive inputs from multiple client devices and manage multiple videoconference sessions, in accordance with some embodiments.

FIG. 7 depicts an example of a virtual whiteboard graphical user interface that may be displayed on a client device, in accordance with some embodiments.

FIGS. 8A-8B depict an example of a virtual whiteboard graphical user interface that may be displayed on a client device, in accordance with some embodiments.

FIG. 9 depicts an example of a virtual whiteboard graphical user interface that may be displayed on a client device, in accordance with some embodiments.

FIG. 10 depicts a flow chart of an example process for initiating multiple videoconference sessions using a virtual whiteboarding application.

FIG. 11 depicts an example hardware for devices of the systems described herein.

While the invention as claimed is amenable to various modifications and alternative forms, specific embodiments are shown by way of example in the drawings and are described in detail. It should be understood that the drawings and detailed description are not intended to limit the invention to the particular form disclosed. The intention is to cover all modifications, equivalents, and alternatives falling within the scope of the present invention as defined by the appended claims.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Embodiments disclosed herein are directed to systems and methods for initiating and managing videoconferences within a virtual whiteboard session using a virtual whiteboard application. A virtual whiteboard application can have a canvas region which allows for shared editing capabilities. For example, multiple users can concurrently edit, add graphical objects, delete items, move items, and so on. The canvas region may allow graphical objects and/or any other content to be placed anywhere within the region. In other words, the canvas region allows users to place content without grid restrictions, margins, or size limitations (e.g., freeform). Participants to a whiteboarding session may create graphical objects, which may be referred herein as user-defined graphical objects including user-generated content. For example, the user-defined graphical objects may include or be similar to sticky notes, a participant user may generate and place a user-defined graphical object on the virtual whiteboard graphical user interface in a virtual canvas.

Each user may interact with the canvas region using a client device that displays a virtual whiteboard graphical user interface (GUI). The virtual whiteboard GUI one each client device may display a portion of the canvas along with other virtual tools which may be used to navigate and/or interact with the canvas by generating and editing virtual objects. Accordingly, different client devices may simultaneously display and interact with different portions of the canvas. For example, a first set of users may be collaborating at a first portion of the canvas and may be adding and/or editing virtual objects to the first portion of the canvas. Simultaneously, a second set of users may be collaborating at a second portion of the canvas and may be adding and/or editing virtual objects to the second portion of the canvas.

Communication between users during a collaboration whiteboarding session may occur using a videoconference. Traditional whiteboard apps may utilize a single video-conference for all the users. However, this only allows a single topic to be discussed at a time. Alternatively, splitting users into break-out rooms requires upfront planning and communication on what will be discussed in each breakout room. Accordingly, moving between topics can be challenging.

The system described herein, can monitor each client device's interaction and/or location within a virtual whiteboard during a whiteboard session, and dynamically initiate different videoconferencing sessions based on each user's interaction with the virtual whiteboard. For example, the system may determine that a first group of users are interacting with a first area/topic and initiate a first videoconference for the first group of users. Similarly the system may determine that a second group of user are interacting with a second area/topic and initiate a second videoconference for the second group of users.

As users move to different areas/topics on the virtual whiteboard, the system may update the videoconferences based on the movement of the users. For example, the if a user moves from the first area/topic and starts engaging with the second area topic, the system may remove the user from (or prompt to the user to leave) the first video conference and add the user to (or invite the user to join) the second video conference. Accordingly, multiple video conferences can be adjusted in real-time based on monitored interactions of the users with a virtual whiteboard.

The whiteboarding application can include a user interface, which shows an overview of the whiteboard and active videoconferencing sessions. For example, the user interface may show a map that indicates topics associated with different areas of the virtual whiteboard and any active video conferences associated with each area/topic. In some cases, the map may include a list of users associated with different areas or other visual indicator (e.g., avatar icons) showing which users are engaging with particular topics. The user interface may be displayed as part of the whiteboarding session, so that each user can keep track of what is going on at other parts of the whiteboard in real time.

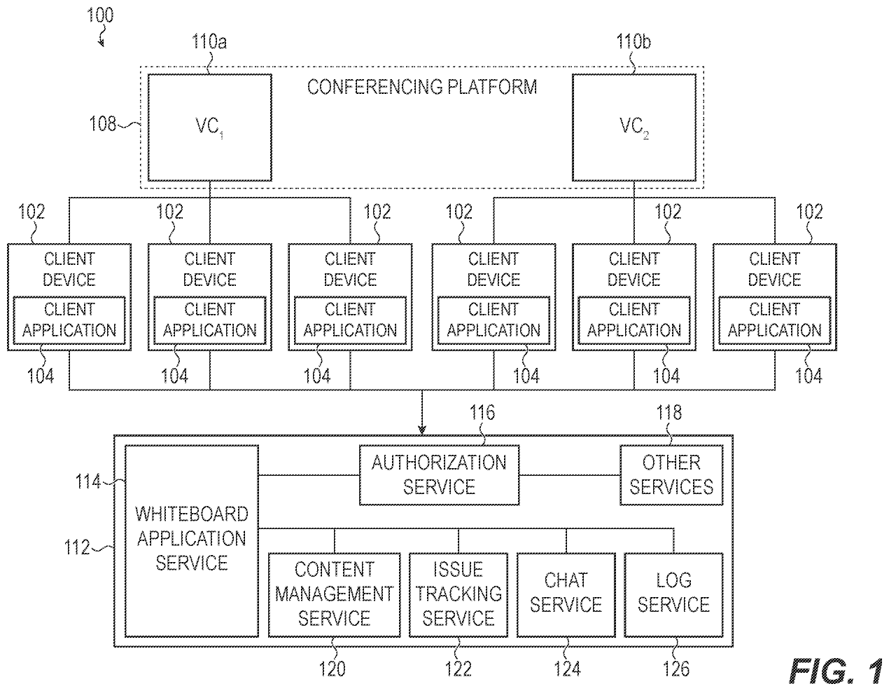

These foregoing and other embodiments are discussed below with reference to FIGS. 1-11. However, those skilled in the art will readily appreciate that the detailed description given herein with respect to these figures is for explanation only and should not be construed as limiting.

FIG. 1 depicts a simplified diagram of a virtual whiteboard system 100, as described herein. The system 100 is depicted as implemented in a client-server architecture or client-service architecture, but it may be appreciated that this is merely one example and that other communications architectures are possible. In accordance with the examples provide herein, the system 100 of FIG. 1 can be used for collaboration among a group of users using a virtual whiteboard graphical user interface and executing an action with respect to an external platform, such as a videoconferencing application, an issue tracking platform, a content management system, and so on, via a computer network. All or portions of the system 100 may be referred to as virtual whiteboard system, whiteboard system or system, as used herein.

An architecture of the system 100 may allow participant users of a whiteboarding session to share their ideas with other users, create one or more actions to be performed with respect to an issue being managed by an issue tracking platform, or a content item being managed by a content management system, and automatically cause execution of one or more actions with respect to the issue tracking platform and/or the content management system. By way of a non-limiting example, an automatic execution of the one or more actions with respect to the issue tracking platform and/or the content management system is performed as a participant user drags or otherwise positions a graphical object on a virtual canvas where the graphical object is currently placed by the participant user into or on an automation or action region, which may be a user-defined action region, of the virtual whiteboard graphical user interface displayed on the participant user's client device.

The networked computer system or the content collaboration system of FIG. 1 depicts an example configuration in which multiple client devices 102 may access a host server 112 of a set of host servers via a computer network. The host server 112 may be referred herein as a whiteboard platform server 112. The computer network may include a distributed network which may include local networks, gateways, and networking services provided by one or more internet service providers. The client devices 102 are able to collaborate with each other and other users using a conferencing platform 108, and the whiteboard platform server 112 providing a whiteboarding application service 114. In the present example, the conferencing platform 108 is depicted as being separate from the platform server 112, in some instances, some or all of the services of the conferencing platform may be integrated with or provided by a service operating on the platform server 112.

In general, the conferencing platform 108 may provide audio, video, and/or audiovisual conferencing services. The conferencing platform 108 may also be used to share a single instance of a whiteboard application being executed on a client device as a frontend of the application in conjunction with the backend provided by the whiteboard application service 114. The conferencing platform 108 may share a single instance of the whiteboard application, while the backend whiteboard application service 114 concurrently provides the same whiteboard session to multiple client devices. As a result, the participants in a videoconference or telephone conference provided by the conferencing platform 108 may be the same (or have participants in common) with participants of a whiteboarding session.

The conferencing platform 108 may be used to initiate multiple videoconference session 110 that are each associated with a whiteboarding session (e.g., hosted by the platform server 112). For example, the conferencing platform 108 may be configured to host a first videoconference 110a having a first set of participants and a second videoconference 110b having a second set of participants. The conferencing platform 108 may be configured to update the participants in each videoconferencing session 110 based on inputs received from the platform server 112 and/or send indications of changes to participants of each videoconference 110 to the platform server 112. For example, the conferencing platform 108 may send invitations to join a videoconference 110 to user devices based on inputs from the platform server (e.g., in response to the platform servers 112 determining that a set of reference locations satisfy a cluster criteria, as described herein). Additionally or alternatively, the videoconferencing platform may send indications to the platform server 112 of users leaving a videoconferencing session 110, joining a videoconferencing session 110 or other inputs received from client devices by the conferencing platform 108.

The whiteboarding application service 114 may display a virtual board or virtual canvas in a virtual whiteboard graphical user interface displayed on a display of each of the client devices 102, and a participant user can collaborate using the whiteboarding application service 114 via the network either directly or through the other services by the collaboration platform server 112. Additionally, or alternatively, the whiteboarding application service 114 may allow or enable a user of a client device to work individually and perform automation with respect to one or more external platforms, as described herein. Accordingly, the collaboration platform server 112 of the set of host servers may include multiple platform services, which may be part of the content collaboration system 100. For example, the multiple platform services may include, but not limited to, a content management service 120, an issue tracking service 122, a chat service 124, a logging service 126, an authorization service 116, and other services 118, and so on. A platform service of the multiple platform services may be implemented as one or more instances of the platform service executing on one or more host servers of the set of host servers.

The whiteboarding application service 114, may track client device interactions with the virtual canvas and locations of interactions. For example, as client device display and/or provide inputs to a virtual canvas, the whiteboarding applications service 114 may determine and update a reference location associated with each client device. The whiteboarding applications service 114 may also track content objects created and/or modified by each client device and associate those content objects (and/or modifications to content objects) with a particular user account that is associated with the respective client device. Additionally or alternatively, the whiteboarding applications service 114 may my continually or periodical evaluate a spatial grouping of content objects on the virtual canvas and/or spatial groupings of client devices with respect to other client device and/or content objects. The whiteboarding application service may send request to the conferencing platform 108 (e.g., API requests) to initiate and/or update one or more videoconferences hosted by the conferencing platform 108 based on the spatial groupings of client device and content objects as described herein.

The multiple platform services may also provide different services including, for example, issue tracking services for creating, managing, and tracking issues for software development, bug tracking, content management services for creating, managing, and searching content items, and/or information technology service management (ITSM) services. Also, while the various platform services 120, 122, 124, 126, and 118, and so on, are all depicted as being provided by the same server 112 or set of servers, each of the platforms may be implemented on a separate server that is distinct from the server 112. Depending on the implementation and the platform provider, the various platforms 120, 122, 124, 126, and 118, and so on, may be provided by a third party and may be referred to as third-party platforms.

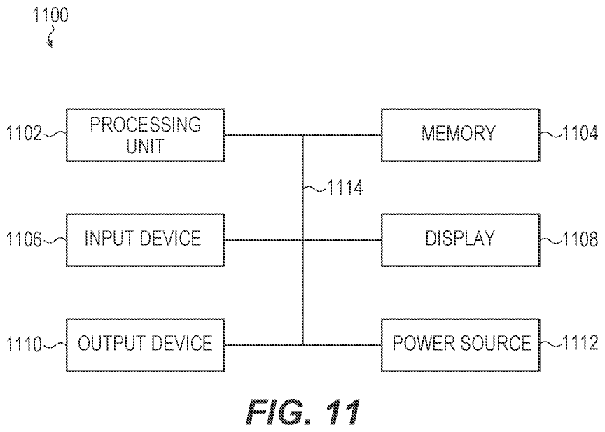

The client devices 102 execute or operate respective example client applications 104, which may include a dedicated client-side application or may be a web browser client application. The client applications 104 may also be referred to herein as frontend applications and may provide one or more graphical user interfaces, for example, virtual whiteboard graphical user interfaces, for interfacing with the backend applications or services provided by the host server 112. The client devices 102 typically include at least one display, at least one processing unit, at least one computer memory, and other hardware components. An example device including hardware elements is described below with respect to FIG. 11

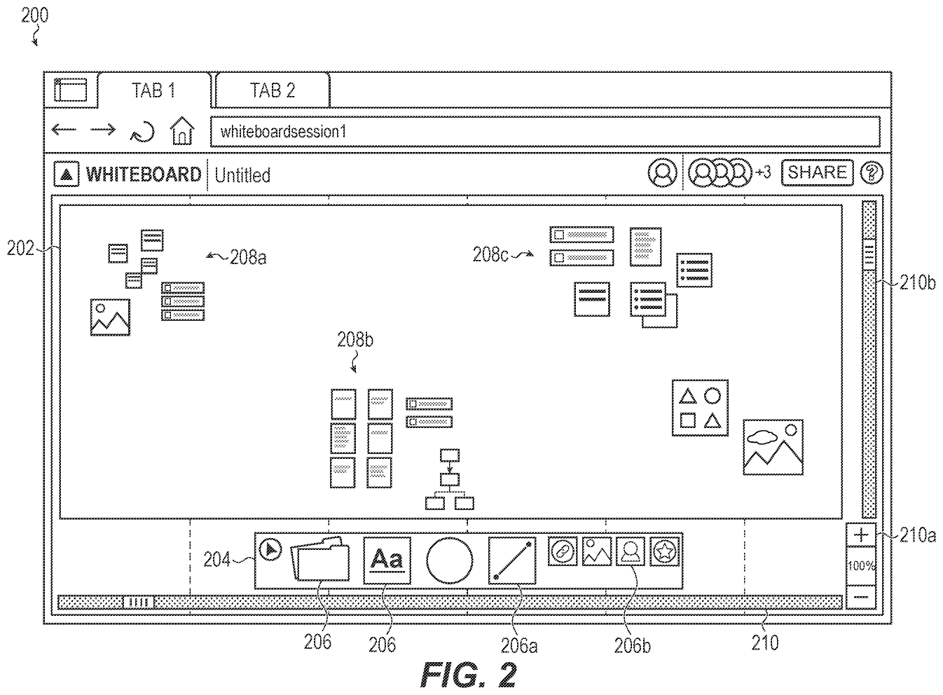

The frontend applications 104 executing on the client devices 102, may also be referenced herein as a whiteboard application, whiteboard frontend or a whiteboarding application instance, and may display a virtual whiteboard graphical user interface (or a graphical user interface of a whiteboarding application instance) according to example views shown in FIGS. 2-10, as discussed below. A participant user can create a graphical object (also referred herein as a user-defined graphical object), having properties, for example, a text and/or an icon, on the virtual whiteboard graphical user interface using the whiteboarding application service 114 during a whiteboarding session. Each graphical object may further have properties including a shape, a size, and/or a color in which the graphical object is displayed on the virtual whiteboard graphical user interface on the client devices 102. The properties of the graphical object may be visible properties to participant users of the whiteboarding session in accordance with a permission granted to each participant user based on their respective user profile.

In some embodiments, and by way of a non-limiting example, properties of each graphical object may uniquely identify a participant user who created the graphical object. Additionally, or alternatively, the properties of the graphical object may uniquely identify whether the graphical object corresponds to a graphical object associated with an issue managed by an issue tracking platform, or a graphical object associated with a content item managed by a content management system. For example, graphical objects created by a participant user User-A may each be of red color, while graphical objects created by a participant user User-B may each be of blue color, or graphical objects associated with an issue managed by an issue tracking platform may be of a square shape and graphical objects associated with a content item managed by a content management system may be of a rectangle shape.

A participant user of the whiteboarding session and/or a host of the whiteboarding session may configure properties of the graphical object, for example, the shape, the size, and the color for each graphical object, according to various criteria as described herein. In some cases, the graphical objects may be created from object primitives or templates that preconfigure the object to a particular form or media type. Example object primitives include, note primitives, text primitives, emoji or sticker primitives, shape primitives, connector primitives, and automation or action primitives, as described herein. For example, the participant user of the whiteboarding session and/or the host of the whiteboarding session may designate one or more action regions using an action or automation primitive and configure rules to perform one or more actions and/or automations when a participant user of the whiteboarding session moves a graphical object into the respective action or automation region. An action or automation region, as described herein, may be a user-defined action region, or a pre-defined action region that is added by a participant user or a host user of the whiteboarding session for display on the virtual whiteboard graphical user interface. Properties of the pre-defined action region may be preconfigured and may not be updated by the participant user or the host user of the whiteboarding session. However, properties of the user-defined action region may be dynamically updated by the participant user or the host user of the whiteboarding session. The action region is displayed on the virtual whiteboard graphical user interface as distinct from the virtual canvas displayed on the virtual whiteboard graphical user interface.

Accordingly, participant users can collaborate using a virtual whiteboard, which is presented on a display of each client device as a virtual whiteboard graphical user interface, and automatically cause execution of an action according to the configured rules of an action region, when a participant user places a graphical object into the action region of the virtual whiteboard graphical user interface. The participant user may place the graphical object into the action region by dragging the graphical object from its current location in the virtual canvas on the virtual whiteboard graphical user interface to any place within the action region on the virtual whiteboard graphical user interface. Additionally, or alternatively, the participant user may edit properties of the graphical object corresponding to a display location of the graphical object on the virtual whiteboard graphical user interface to move the graphical object from the virtual canvas into the action region.

As shown in FIG. 1, the content collaboration system 100 includes a host server 112 (also referred herein as a collaboration platform server 112) of a set of host servers, which may be a host of multiple platform services. The host server 112, which may use one or more virtual or physical computing resources (collectively referred in many cases as a “cloud platform”). In some cases, the set of host servers can be physically collocated or in other cases, each may be positioned in a geographically unique location.

The host server 112 of the set of host servers can be communicably coupled to one or more client devices by a network. Multiple example client devices are shown as the client devices 102, and 104. The host server 112 of the set of host servers may include one or more host services and/or other server components or modules to support infrastructure for one or more backend applications, each of which may be associated with a particular software platform, such as a documentation platform or an issue tracking platform. The documentation platform may be a document management system or a content management system, and the issue tracking platform may be an issue management system, and so on. For example, the host server 112 may host a whiteboarding application service 114, an authorization service 116, a content management service 120, an issue tracking service 122, a chat service 124, and other services 118. The host server 112 may also include a logging service 126. The host server 112 may also have a local cache to store an events history corresponding to each whiteboarding session, which may be used to generate and communicate a report describing various actions performed during the whiteboarding session to participant users of the whiteboarding session. Additionally, or alternatively, a local database, a remote database, and/or a cache (for example, in a cloud environment) may be used to store the event history.

Accordingly, the whiteboarding application service 114 may provide an interface to client devices 102 to the one or more backend applications, and/or software platforms, such as a content management system or an issue tracking platform during collaboration with other users during a whiteboarding session or working individually to perform an automation with respect to one or more external platforms, as described herein. The client devices 102, and 104 may be executing a frontend application that consumes services provided by the whiteboarding application service 114 during the whiteboarding session. By way of a non-limiting example, the interface provided by the whiteboarding application service 114 may be webservice based, such as a Representational State Transfer (REST) webservice. The electronic documents, pages, or electronic content may be transferred between a client device and a host server using one or more of JavaScript Graphical object Notation (JSON), Extensible Markup Language (XML), Hypertext Markup Language (HTML), and/or a proprietary document format. Additionally, or alternatively, the interface provided by the whiteboarding application service 114 may be as a plugin of a web browser or a web extension of a web browser.

In some embodiments, a user may be admitted to a whiteboarding session, or the user may be permitted to perform an automation with respect to one or more external platforms, based on authentication and/or authorization of a user using the authorization service 116. The authorization service 116 may authenticate a user based on user credentials, which may include a username or other user identification, password or pin, biometric data, or other user-identifying information. The user credentials may be stored and tracked using a token, an authentication cookie, or other similar data element. Upon successful authentication/authorization of a user, the whiteboarding application service 114 may retrieve a user profile associated with an authenticated user of a client device. The user profile associated with the user may suggest various permissions of a user for creating, editing, accessing, searching, and/or viewing various electronic documents, pages, electronic content, issues, tickets on the content management system and/or the issue tracking platform. The user profile associated with the user may also identify other details of the user, including but not limited to, a role of a user in an organization, a role of the user during the whiteboarding session, one or more groups to which a user is a member, other users of the one or more groups to which the user is a member, one or more projects related to the user, one or more issues or tickets (managed by the issue tracking platform) the user is assigned to, and so on. The user profile may include, but not limited to, user permission settings or profiles, and user history that may include user logs or event histories, system settings, administrator profile settings, content space settings, and other system profile data associated with the backend applications described herein and associated with the user. The user profile may also include user permission settings or profiles corresponding to performing an automation with respect to one or more external platforms. Accordingly, the user of the client device may participate and perform various actions including an automation with respect to the issue tracking platform and/or the content management system based on the retrieved user profile. The other services 118 described herein may provide a user interface to other applications or services, for example, an audio and/or a video recording of the whiteboarding session.

While the whiteboarding application service 114 is configured to enable collaboration among participant users on a virtual whiteboard displayed as a virtual whiteboard graphical user interface on a display of each client device, the chat service 124 may provide other services related to a chat interface or a messaging interface during the whiteboarding session. The logging service 126 may log various events, messages, alarms, notifications, and so on, for debugging purposes. The logging service 126 may also log properties of a whiteboarding session including, for example, a start time and an end time of the whiteboarding session, a time when each participant user of the whiteboarding session joined and/or left the whiteboarding session, etc., which may be used to generate and communicate a report describing various actions performed during the whiteboarding session to participant users of the whiteboarding session.

The content management service 120 may be a plug-in, a module, a library, an API, and/or a microservice providing interface to a content management system (not shown) managing content items. Alternatively, the content management service 120 may manage content items for the content collaboration system 100. Using the interface provided by the content management service 120, one or more content items managed by the content management system may be updated, edited, deleted, viewed, and/or searched as described herein in accordance with the parsed text and/or icons of graphical objects, and/or in accordance with an action configured for an action region, as described herein. A new content item or a template for a new content item may also be created on the content management system using the interface provided by the content management service 120. Thereby, a participant user is not required to launch an instance of the content management system web browser application separately to perform operations with respect to one or more content items managed by the content management system during a whiteboarding session. In some cases, the content management service 120 may be a documentation or wiki service that provides documents or pages of a document space or page space. The pages or documents may include user-generated content used to document projects, products, or services for an organization. In some cases, the pages or documents are implemented as part of an information technology service management (ITSM) system for providing documentation for solving user issues or technical problems.

The issue tracking service 122 may be a plug-in, a module, a library, an API, and/or a microservice providing an interface to an issue tracking platform (not shown) managing issues or tickets. Using the interface provided by the issue tracking service 122, one or more issues managed by the issue tracking platform may be updated, edited, deleted, viewed, and/or searched as described herein in accordance with the parsed text and/or icons of graphical objects, and/or in accordance with an action configured for an action region, as described herein. A new issue or a template for a new issue may also be created on the issue tracking platform using the interface provided by the issue tracking service 122. Thereby, a participant user is not required to launch an instance of the issue tracking platform web browser application separately to perform operations with respect to one or more issues managed by the issue tracking platform during a whiteboarding session. By way of a non-limiting example, any service described herein may be a plug-in, a module, a library, an API, and/or a microservice providing a respective interface. The issue tracking service 122 may also be operated as part of an ITSM system used to track tickets or technical issues raised by users or clients.

FIG. 2 depicts an example of a virtual whiteboard graphical user interface (GUI) 200, in accordance with embodiments described herein. The virtual whiteboard GUI 200 may be displayed by a client device participating in a virtual whiteboard session and show an example of an instance of virtual whiteboard GUI. The system may cause a GUI to be displayed on each client device participating in the virtual whiteboard session and each GUI may be response to inputs from a corresponding client device.

The virtual whiteboard GUI 200 can include a virtual canvas 202 where users participating in a whiteboard session may simultaneously create and modify virtual content objects using a client device as described herein. The virtual whiteboard GUI 200 may also include a control region 204, which may include one or more virtual tools 206 (some of which are labeled), which may be used to create and modify content objects within the virtual canvas 202. For example, the control region 204 may include a first tool 206a for adding a sticky note to the virtual canvas. In response to using the first tool 206a to add the sticky note, the system may generate a graphical object that includes text and/or other content input at a first client device by a first user. The system may associate the sticky note with the first user and/or may allow other users to add to or otherwise edit the sticky note object. The control region 204 may include any other suitable tools. For example, the control region may include a second tool 206b that can be used to associate a particular user with a content item. The second tool 206b may be used to assign a particular task to one or more users.

In some cases, the virtual canvas 202 may be configured to allow different group of users to simultaneously collaborate in different regions of the virtual canvas 202. The whiteboard GUI 200 may allow users to zoom to different levels of detail, and the size of the virtual canvas 202 may be configured to show varying levels of detail based on the zoom level. For example, at a zoom level that allow the entire virtual canvas 202 to be displayed within a viewport of the client device, the whiteboard GUI 200 may show high level details that represent the location of content objects, but may not display specific detail (such as text associated with a particular content object). As a client device increase a zoom the system may cause a portion of the virtual canvas 202 to be displayed (e.g., a particular region), and may display additional details associated with particular content objects (e.g., text, images, and so on).

As used herein, the term “viewport” may be used to refer to a portion of the virtual canvas that is rendered or displayed in the graphical user interface of a respective client device. The viewport may have a unique location, level of zoom, and boundary depending on input provided by the user and/or a size and configuration of the display of the client device.

The virtual canvas 202 may be configured to allow the generation of different groups of content at different regions and provide enough space that the different groups are visually separated from each other. For example, a first region of the virtual canvas 202 may include a first set of virtual content objects 208a, a second region of the virtual canvas 202 may include a second set of virtual content objects 208b, a third region of the virtual canvas 202 may include a third set of virtual objects 208c and so on. In some cases, the first set of content objects 208a may be associated with a first collaboration topic (e.g., topic of discussion, issue, etc.), the second set of content objects 208b may be associated with a second collaboration topic, the third set of content objects 208c may be associated with a third collaboration topic and so on.

In some cases, various users may transition between different sets of content objects to view and/or contribute to a particular set of content objects (e.g., add and/or modify content objects in the first set of content objects). Accordingly, user's may use their client device to freely navigate within the virtual canvas 202 to view and/or interact with different regions, which may be associated with different sets of content objects.

The whiteboard GUI 200 may include navigation tools 210, which allow a user to change what portion of the virtual canvas 202 is displayed in a viewport of their client device. For example, a first zoom level may display the entire virtual canvas 202 within a viewport of the client device. As a user increase a zoom level, for example using a zoom tool 210a, the client device may display only a portion of the virtual canvas 202 and the size of the content objects may increase. The navigation tool may also include translations tools including a first translation tool 201b, which may allow navigation along a first direction and a second translation tool 210c, which may allow navigation along a second direction. Inputs to these tools may cause the portion of the virtual canvas 202 that is displayed within the viewport to be updated. The navigation tools 210 shown in FIG. 2 are provided as an example and other navigation tools can be used. For example, the navigation tools 210 may allow click and drag inputs to be used to translate the virtual canvas 202, touch inputs, and/or any other suitable tools.

The view port of a client device may be defined by the visual area of the virtual canvas 202 that is currently displayed on a client device. In the cases of web-based interfaces the viewport may be defined by a webpage GUI. In the cases of application-based interface the viewport may be defined by the application GUI. In any cases, a viewport may include less than the entire display area of a client device. That is, the viewport, as used herein, may refer to the portion of the virtual canvas 202 that is displayed on a client device at any given time. The content shown within a viewport can change as a user navigates the virtual canvas 202.

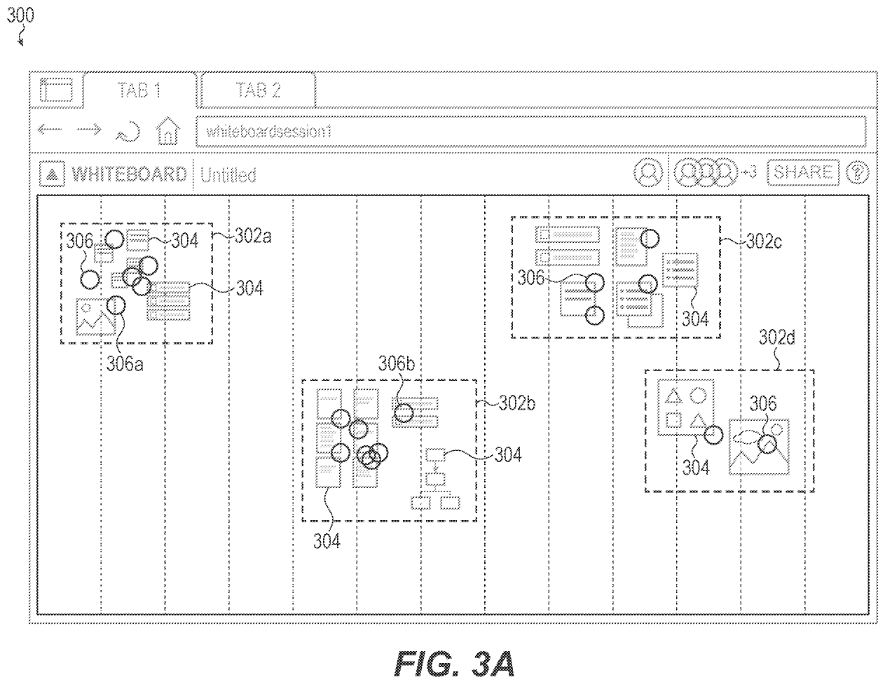

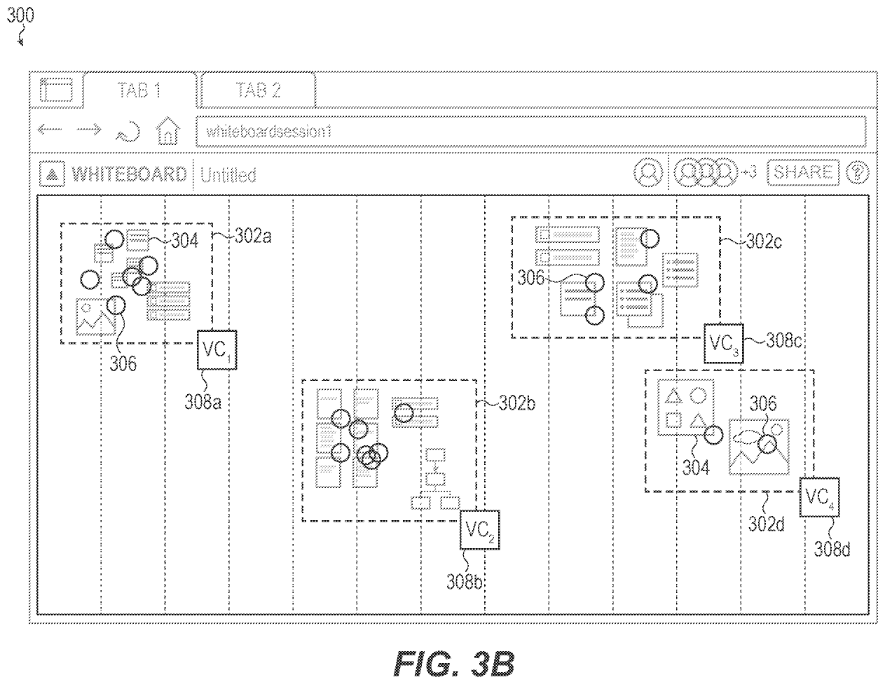

FIGS. 3A-3B depict examples of a virtual canvas 300 that is configured to receive inputs from multiple client devices and manage multiple videoconference sessions, in accordance with some embodiments. FIGS. 3A and 3B depict a visual example of client device tracking that may be performed by a back-end of the system (e.g., the platform server 112 and/or the whiteboard application service 114). The whiteboard application service (e.g., whiteboard application service) may track interactions of client devices with the virtual canvas 300 including the creation and modification of virtual content items, viewports displayed by each client device and so on.

In some cases, the whiteboard application may use data generated from the interactions of the client devices with the virtual canvas 300 to initiate one or more videoconferences sessions. For example, the whiteboard application may identify groups of content objects 302 and/or determine reference locations 306 for each client device within the virtual canvas 300. A reference location may be used to identify an area that particular user is engaged with or has contributed to. Using the grouping of content objects 302 and/or the references locations, the whiteboard application may cause one or more video conferences to be initiated and/or updated, which may allow users to participate in a live videoconference to discuss the content items that they are collaborating on. The system may support multiple independent videoconference calls each associated with a different region of the whiteboard application.

As shown in FIG. 3A, the whiteboard application service may identify one or more groups of content objects 302. For example, the system may monitor the location of content objects 304 (only some of which are labeled) within virtual canvas 300 and in response to a subset of content items satisfying a criteria the system may classify the subset of content items as a group. In some cases, as content objects are created and/or modified the system may analyze the spatial relationship of the content items. This may include performing a clustering analysis or other spatial grouping analysis to identify groups of related content items. For example, the system may perform a spatial grouping analysis to identify a first set of content objects 302a, a second set of content objects 302b, a third set of content objects 302c and a fourth set of content objects 302d within the virtual canvas 300.

The system may also track users' interaction with the virtual canvas 300 to associate one or more users with a particular set of content objects 304 and/or identify a groups of users that are collaborating on a topic. In some cases, the system may be configured to determine a reference location 306 (only some of which are labeled) for each client device that is part of a whiteboarding session and displaying the virtual canvas 300. The reference location 306 may be used to associate a user with a particular region of the virtual canvas 300 and/or with particular content objects 304. The reference location 306 may be a location of the virtual canvas that is associated with each client device and thereby associated with a corresponding user account.

In some cases, a reference location 306 for a client device may be based on a viewport that is displayed by the corresponding client device. For example, a first client device may include a viewport that is displaying a first portion of the virtual canvas. The system may determine a first reference location 306a based the viewport that is being displayed on the first client device. A second client device may display include a viewport that is displaying a second portion of the virtual canvas. The system may determine a second reference location 306b based on the viewport being displayed by the second client device.

Additionally or alternatively, the system may determine a reference location for each client device based on interactions with the virtual canvas 300 and/or content object displayed on the virtual canvas 300. For example, if a user creates, modifies or otherwise interacts with a virtual content object, the system may associate an object reference location 306 with the corresponding client device. The object reference location may be based on the location of the content object. Accordingly, if a user navigates to a different portion of the virtual canvas 300, the object reference location may continue to indicate the current position of the content object and also be associated with a client device that has is viewing/interacting with a different portion of the virtual canvas 300.

The system may perform spatial grouping analysis on the references locations 306 for each client device to identify groups of user and/or associate a groups of users with a particular set of content objects 302. For example, the system may perform clustering analysis on the reference locations 306 for each client device participating in a whiteboarding session. In response to identifying that a set of reference locations satisfy a cluster criteria, the system may associate each of the corresponding client devices (and associated user accounts) as a group. In some cases, the clustering criteria may be based on the position of each reference location within the virtual canvas 300. For example, the clustering criteria may be satisfied based on a clustering analysis identifying at least two reference locations as belonging to distinct cluster.

Additionally or alternatively, the clustering criteria may be based on a set of content objects. The system may perform a clustering analysis (or other spatial grouping analysis) and identify a set of content objects associated with a particular region of the canvas 300. The system may determine that a group of client device satisfy a cluster criteria in response to determine that a reference location for each client device is within a defined distance from the set of content objects. Determining a distance between each client device and a set of content objects may be performed in a variety of ways. For example, the system may determine a centroid for a set of content items and determine a distance between the content items and a reference location of each client device. Identifying multiple client devices that are within a defined distance from the centroid of the set of content items may be considered to satisfy the clustering criteria.

In other cases, the system may determine that a clustering criteria is satisfied based on comparing the reference location of multiple client devices with respect to each other. For example, in response to determining that the reference locations of multiple client devices are within a defined range they system may determine that the clustering criteria is satisfied for those client devices.

Additionally or alternatively, the clustering criteria may include a time duration, which may be used to determine that a user has interacted with and/or viewed a particular portion of the virtual canvas for a long enough period of time before identifying a group of users or associating a user with an established group. The time duration may reduce instances where a client device is navigating around different regions of the virtual canvas and/or briefly viewing a particular region without substantively engaging with that region of the virtual canvas.

The system may identify multiple different groups of client device that each independently satisfy a clustering criteria. For example, the system may determine that a first set of client devices satisfy a clustering criteria for the first set of content objects 302a, a second set of client device satisfy a clustering criteria for the second set of content objects 302b, a third set of client devices satisfy a clustering criteria for the third set of content objects 302c and a fourth set of client devices satisfy a clustering criteria for the fourth set of content objects.

The system may cause one or more video conferences to be initiated in response to determining that a set of client devices satisfy a clustering criteria. As shown in FIG. 3B, the system cause a first videoconference 308a the be initiated for a first set of client devices that satisfy a clustering criteria with respect to a first region, a second videoconference 308b to be initiated for a second set of client devices that satisfy the clustering criteria with respect to a second region, a third videoconference 308c to be initiated in response to a third set of client devices satisfying the clustering criteria with respect to a third region, and a fourth videoconference 308d to be initiated in response to a fourth set of client devices satisfying a clustering criteria with respect to a fourth region.

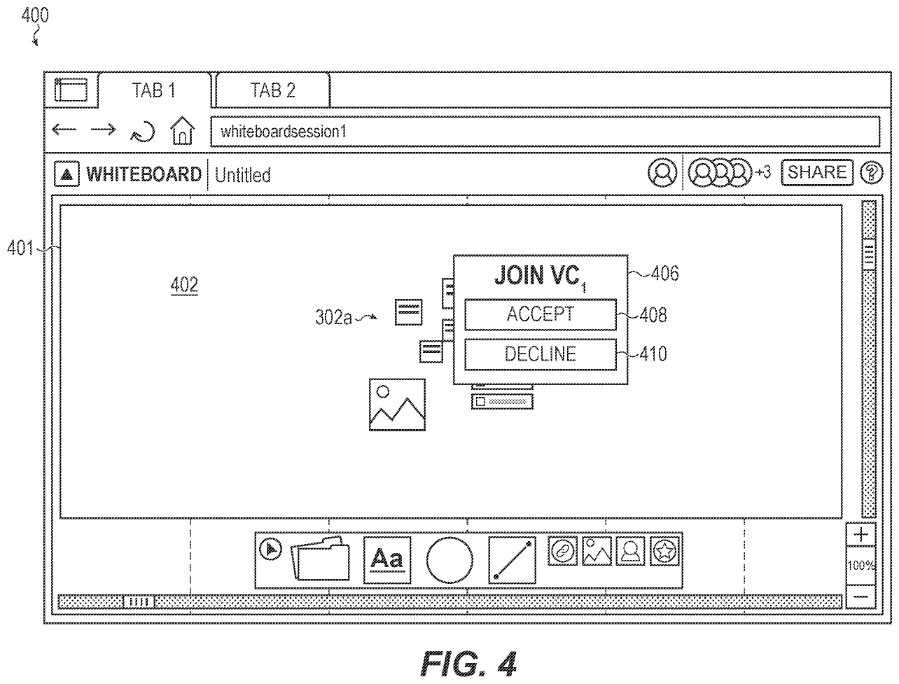

FIG. 4 depicts an example of a virtual whiteboard GUI 400 that may be displayed on a client device, which may be an example of the embodiments described herein. The virtual whiteboard GUI 400 may be displayed in response to determining that a set of client devices satisfy a clustering criteria as described herein. The virtual whiteboard GUI 400 may include a virtual canvas 402, which displays virtual content objects as described herein.

The viewport 401 displayed by the client device may display a portion of the virtual canvas 402 that includes the first set of content objects 302a. The system may determine that the client device is associated with a set of client devices that satisfy a clustering criteria with respect to the first set of content items. The system may cause the client device to display a prompt 406 which may include a first selectable option 408 to participate in a videoconference (e.g., the first videoconference 308a) that is associated with the first set of content items. In some cases the prompt 406 may also include a second selectable option 409, which result in the client device declining to join the video conference. The prompt 406 may be displayed as part of the virtual whiteboard GUI 400. In response to a selection of the first selectable option 408, the system may cause the client device to join the video conference (e.g., the first videoconference 308a). The system may cause a prompt (e.g., prompt 406) to be displayed on each client device that satisfies the clustering criteria.

In some cases, the whiteboard application service may cause the prompt to be displayed and in response to a user selecting the first selectable option 408 to join the videoconference the whiteboard application (e.g., whiteboard application 114) may communicate with the conferencing platform 108 via a request to add the corresponding use to a respective videoconference. For example, the whiteboard application service may use one or more API calls to videoconferencing platform 108 to initiate and/or request changes to client devices participating in one or more videoconferences.

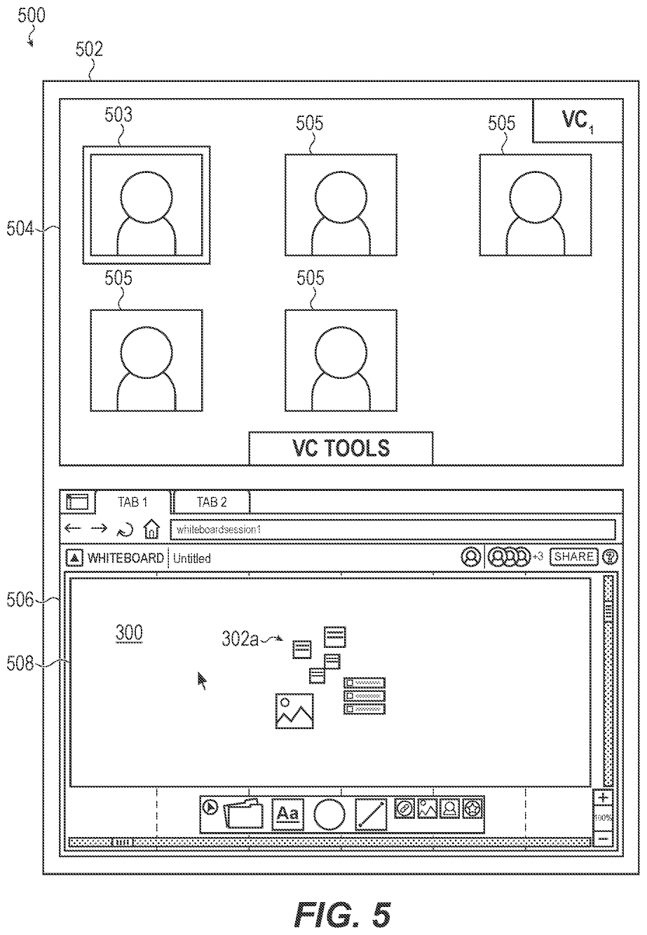

FIG. 5 depicts an example of a virtual whiteboard GUI 500 that includes a videoconference that may be displayed on a client device, in accordance with embodiments described herein. In some cases, the virtual whiteboard GUI 500 may be displayed in response to a user selecting an option to join a videoconference, as described herein. The system may cause a videoconference interface 504 to be displayed in a first portion of a viewport of the client device and a virtual canvas 508 to be displayed in a second portion of the viewport of the client device. The videoconference interface 504 may be supported by the videoconferencing platform (e.g., conference platform 108) and the virtual canvas 508 may be supported by the whiteboard application (e.g., whiteboard application 114). The videoconference interface 504 may include a video stream for each user 503 participating in the video conference and may include videoconference tools.

In some cases, the system may cause each client device that is part of the video conference to display a particular portion of virtual canvas 508 that is associated with the video conference. For example, the system may determine that each client device satisfied a clustering criteria for a region of the virtual canvas associated with the first set of content objects 302a. In response to initiating the video conference, the system may cause each client device to display the same region of the virtual canvas associated with the first set of content objects 302a. In some cases, the system may cause each client device to display the first set of content objects 302a at a zoom level that text and/or other information associated with each content object is viewable.

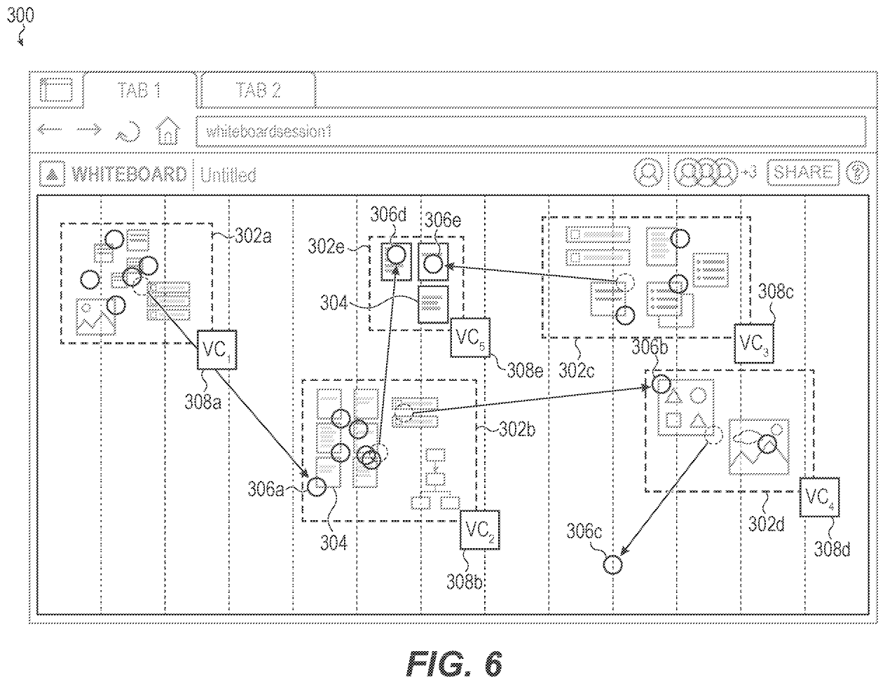

FIG. 6 depicts an example of the virtual canvas 300 that is configured to receive inputs from multiple client devices and manage multiple videoconference sessions, in accordance with embodiments described herein. FIG. 6 depicts an example of the virtual canvas 300 at a second time after detecting one or more interactions from client devices which may include viewport changes, addition of content objects to the virtual canvas 300, modification of content objects and/or other interactions with the virtual canvas 300.

In some cases, the system may monitor inputs from client devices that are participating in a whiteboarding session. In response to detecting an input from a client device, the system may update a reference location for the corresponding client device and determine if any changes to the videoconferences need to be made. In some cases, the system may monitor inputs from client devices in real time and update reference locations in response to receiving an input, detecting a change in the viewport position, and/or detecting other interactions of a client device with the whiteboarding application. In other cases, the system may check for changes at regular intervals. For example, after a defined duration the system may determine a current viewport of each client device and/or determine if a client device interacted with any content items. In some cases, at the defined interval the system may access event logs for a period preceding the interval to determine if there are recent interactions from each client device.

As shown in FIG. 6, at a second time, the system may determine that a reference location of a first client device 306a changed from a first location to a second location. For example, at a first time (e.g., shown in FIG. 3) the first client device 306a may have a reference associated with the first set of content objects 302a. At the second time (e.g., shown in FIG. 6) the system may determine that a reference location of the first client device has moved to second region associated with the second set of content objects 302b. The determined change in the reference location of the first client device 306a may be based on a viewport change of the client device (e.g., due to navigation inputs from a user), an input from the client device (e.g., addition or modification of a content object 304 associated with the second set of content objects), or other interaction of the first client device 306a with the virtual whiteboard GUI.

In some cases, the updated reference location may result in a client device satisfying a cluster criteria associated with a different region of the virtual canvas 300 (e.g., a different set of content objects 302) and/or a different set of client devices. For example, at the second time, the system may determine that the first client device 306a satisfies a cluster criteria with respect to other client devices associated with the second set of content objects 302b. In response to determining that the first client device satisfies the cluster criteria, the system may determine to add the user to a second videoconference 308b associated with the second region of the virtual canvas. For example, the whiteboard application service 114 may send a request to the conferencing platform 108 to add the user account associated with the first client device 106a to the second videoconference 308b.

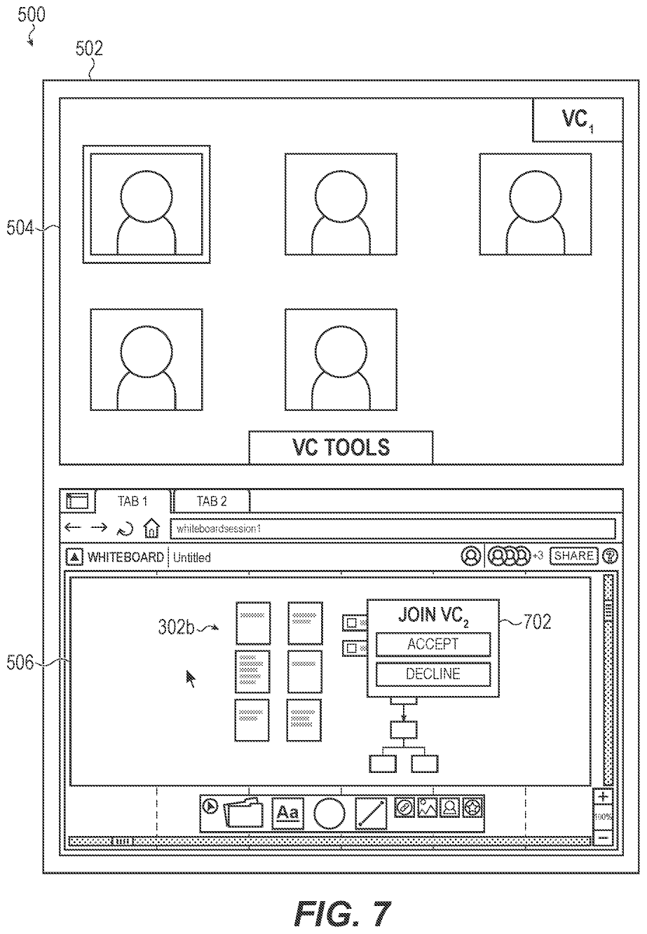

FIG. 7 depicts an example of the virtual whiteboard GUI 500 that may be displayed in response to the whiteboard application service 114 requesting that the user account associated with the first client device 306a be added to the second video conference, as described herein. The GUI shown in FIG. 7 may be updated based on the system determining that the first client device 106a interaction has changed to the second set of content items.

In some cases, the first client device 106a may be participating in the first videoconference 108a, which was a result of the first client device 106a satisfying the clustering criteria at the first time. In some cases, the first client device may continue to participate in the first videoconference 108a (VC1) while navigating to other regions of the virtual canvas 506. For example, at the second time the first client device 106a has navigated to a different region of the virtual canvas 506 associated with the second set of content objects 302b. In some cases, in response to determining that the first client device 106a no longer satisfies the clustering criteria with respect to the first set of content objects 302a, the system may prompt the first client device 106a to leave the first videoconference 108a. In other cases, as at the second time, the system may determine that the first client device 106a satisfies the cluster criteria with respect to the second set of content objects 302b and send a prompt 702 to the user with a first option to join the second videoconference 308b (e.g., selectable accept option) and a second option to decline to join the second videoconference 308b (e.g., selectable decline option). In response to, selecting the first option the system may cause the user to leave the first videoconference 308a displayed in the videoconference interface 504 and join the second videoconference 308b, which can be displayed in the videoconference interface.

Turning back to FIG. 6, the system may detect other changes from client device between the first time (e.g., shown in FIG. 3) and the second time (e.g., shown in FIG. 6). For example, the system may determine that a reference location for second client device 306b changes from a region of the virtual canvas 300 associated with the second set of content objects 302b to a region of the virtual canvas 300 associated with the fourth set of content objects 302d. In response to the system determining that the second client device satisfies a cluster criteria for the fourth set of content objects 302d and/or in relation to other client device that have reference locations at the fourth set of content objects 302d, the system may prompt the client device to leave the second videoconference 308b and join the fourth videoconference 308d.

In some cases, the system may determine that a reference location for client device no longer satisfies a cluster criteria with respect to a set of content items and/or other client devices. For example, at the first time, the reference location for the third client device 306c may satisfy the cluster criteria with respect to the fourth set of content objects 302d and/other client devices in that region. At the second time, the third client device may navigate away from the region associated with the fourth set of content objects 302d and the system may determine that a reference location for the third client device 306c no longer stratifies the cluster criteria. In response, the system may prompt the third client device to leave the third videoconference 308c. In other cases, in response to determining that the third client device 106c has navigated away and no longer satisfies the cluster criteria, the system may automatically remove the third client device 306c from the third videoconference 308c.

In some cases, at the second time, the system may determine that multiple client devices have navigated to a new region of the virtual canvas 300 and may determine that the reference locations for these client devices satisfy a cluster criteria and initiate a new videoconference associated with that region of the virtual canvas 300. For example, between the first time and the second time, the fourth client device 306d may navigate to a new region and begin adding and/or modifying content objects 304 at the new region. A fifth client device 306c may also navigate to the same region and begin adding and/or modifying content objects 304 at the same region. The system may determine that the reference locations for the fourth client device 306d and the fifth client device 306e satisfy a clustering criteria with respect to a fifth set of content objects 302e and prompt the fourth and fifth client devices 306d, 306e to join a video conference (e.g., a fifth videoconference 308c).

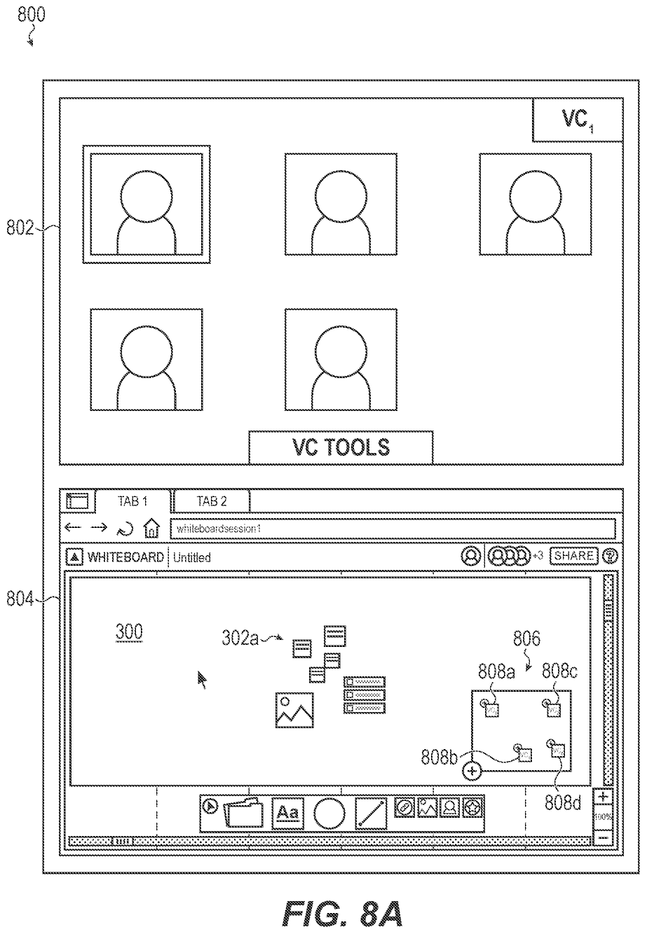

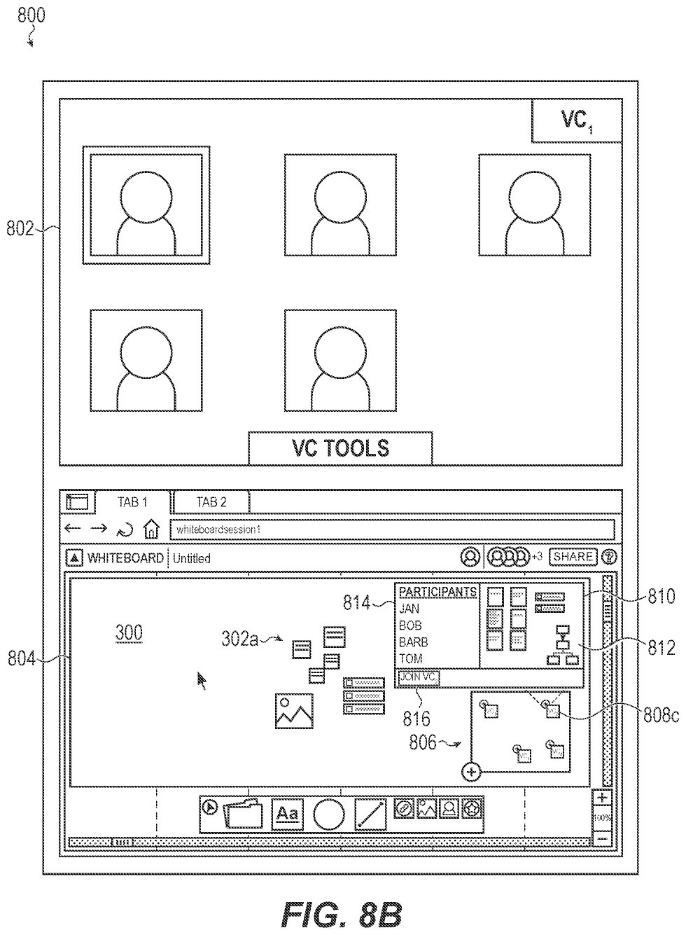

FIG. 8A depicts an example of a virtual whiteboard GUI 800 that may be displayed on a client device, in accordance with embodiments described herein. The GUI 800 may be an example of the graphical user interfaces described herein and include a video conference interface 802 and viewport 804 that displays the virtual canvas 300, as described herein.

In some cases, the whiteboard graphical user interface may include a canvas map 806 that include a set of videoconference indicators 808 that indicate active video conference session occurring within the whiteboard session. The canvas map 806 may be displayed as part of the whiteboard graphical user interface. In some cases, the canvas map 806 may be displayed as an expandable overlay window that is displayed over a portion of the virtual canvas 300. For example, the client device may be participating in the first videoconference 308a and viewing a region of the virtual canvas 300 that includes the first set of content objects 302a. The canvas 806 map may show a view of the entire virtual canvas 300 and include the videoconference indicators 808 that indicate where other active videoconferences are taking place in relation to the virtual canvas 300.

A first indicator 808a may indicate the location of the first videoconference 308a in relation to the entire virtual canvas 303. That is the first indicator 808a may indicate where within the virtual canvas 300 client device participating in the first videoconference 308a are working. A second indicator 808b may correspond to the second videoconference 308b, a third indicator 808c may correspond to the third videoconference 308c, and a fourth indicator 808d may correspond to the fourth videoconference 308d.

FIG. 8B depicts example of the virtual whiteboard GUI 800 that may be displayed on a client device, in accordance with embodiments described herein. In some cases, one or more indicators 808 may include an option to provide additional details about a videoconference and/or activity occurring in a videoconference region.

For example, in response to detecting a selection of the third videoconference indicator from the client device, system may display a summary window 810 that include additional details about the third videoconference 308c and/or the corresponding region of the virtual canvas 300. The summary window 810 may include a first region 812 that displays a preview of a content objects that are associated with the third videoconference 308c (e.g., the third set of content objects 302c). Accordingly, a user of the client device may be able to view what type of content and/or interactions are occurring in relation to the third videoconference 308c while participating in the first videoconference 308a and working at a region of the virtual canvas 300 associated with the first set of content objects 302a.

The summary window 810 may include a second region 814, that displays a list of participants to the third videoconference 308c. For example, the system may identify user accounts that are associated with client devices participating in the third videoconference 308c and display the user accounts names or other information about the users. In some cases, the system may display avatars and/or user account names for each user in the second region 814. The avatars and/or use account names may be active items that can display additional information about an associated user, be sued to communicate with that user, be used to assign a user to a particular content item (e.g., by dragging and dropping the corresponding avatar on a content object), and/or perform other actions specific to the corresponding user.

The summary window 810 may include an option 316 to join the third videoconference 308c. In response to selecting the option 316, the system may cause the client device to leave the first video conference and join the third videoconferences. In some cases, the system may also cause the viewport 804 to update and display a region of the virtual canvas 300 associated with the third videoconference 308c.

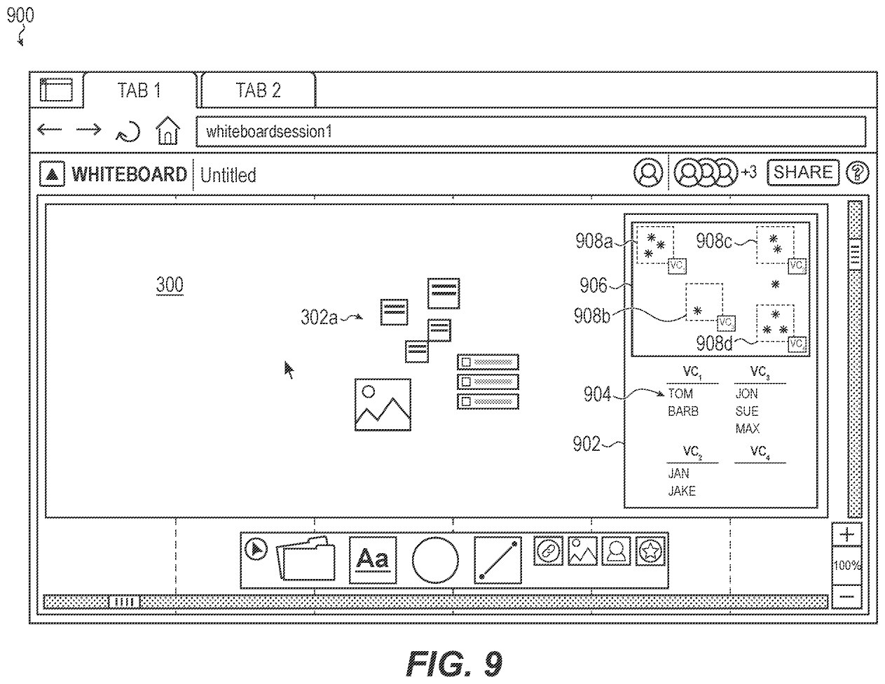

FIG. 9 depicts an example of a virtual whiteboard graphical user interface 900 that may be displayed on a client device, in accordance with embodiments described herein. The graphical user interface depicts another example of canvas map 902 that can provide a user of the client device with information on activity occurring in other region of the virtual canvas 300. For example, the canvas map 902 may include a first region 904 that shows participants for each active videoconference that is occurring in the whiteboarding session.

The canvas map 902 may additionally or alternatively include a second region 906 that indicates activity indicators 908, which may indicate an amount and/or type of activity occurring within the virtual canvas 300. The activity indicators 908 may indicate a number of content objects that have been added to a particular location, recency of additions, type of content be added, amount of interaction at particular regions, amount of users at a particular region and/or associated with a particular videoconference, and so on. For example, the activity indicators 908 may be dynamic objects that change in response to inputs to the virtual canvas. In some cases, the activity indicators 808 may grow in size based on the amount of content in a region. In other examples, the activity indicators may change color based on an amount of interaction that are occurring with content objects in a particular region. Accordingly, a user of the client device (e.g., participating in the first videoconference 308a at a region associated with the first set of content objects 302a) may be able to see an amount of activity occurring in other regions of the virtual canvas 300.

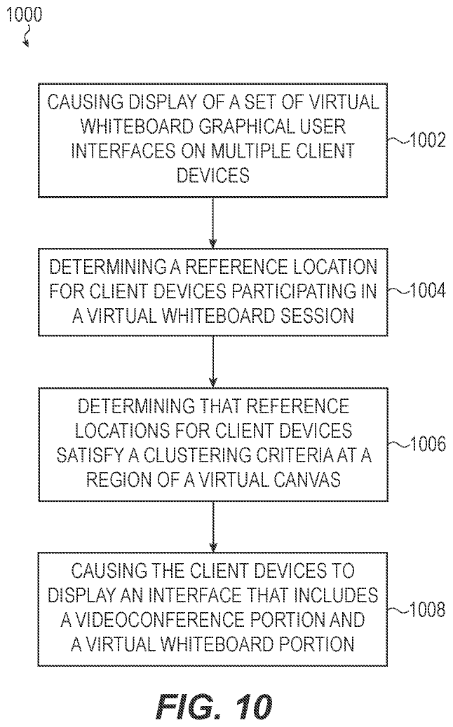

FIG. 10 depicts a flow chart of an example process 1000 for initiating and/or managing multiple videoconference sessions using a virtual whiteboard application. The process 1000 may be performed by the system described herein and may be used to generate the graphical user interfaces and corresponding features described herein.

At operation 1002, the process 1000 can include causing display of a set of virtual whiteboard graphical user interfaces on multiple client devices. The virtual whiteboard graphical user interface on each client device may include a virtual canvas as described herein. Each user may simultaneously and independently manipulate the virtual canvas which may include navigating to different regions of the virtual canvas, adding content objects, modifying content objects and/or performing other interactions with the virtual canvas. The system may dynamically update the virtual canvas at each client device as modification to the virtual canvas are made. For example, if a user of a first client device adds a content item to the virtual canvas, the system may update the graphical user interface on each client device to reflect that addition of the content item. Accordingly, the virtual canvas may be configured to receive simultaneous user inputs from each client device participating in a whiteboard session.

At operation 1004, the process 1000 can include determining a reference location for client devices participating in a virtual whiteboard session. The reference location for a client device may indicate a region of the virtual canvas that a user is focused on and/or interacting with. In some cases, the reference location for a client device may be based on a current viewport that is displaying a portion (or all of) the virtual canvas. For example, the system may use a centroid of the current viewport as the reference location for the client device.

Additionally or alternatively, the system may update or determine a reference location based on user inputs. In some cases, the user inputs may be used to update or modify a reference location determined from the viewport. For example, the default reference location for a client device may be the centroid of the current viewport. As the client device interacts with the virtual canvas, the reference location may be updated. For example, a user may add a content object to the virtual canvas and may place the content object in a peripheral region of the current viewport. The system may update the reference location to bias the reference location to where the user inputs are being received. For example, the updated reference location may be a combination of the centrode for the viewport and a location of an input received from a client device.

In some cases, the reference location may default to a centroid of the viewport of the client device and when an input is received from a client device (e.g., addition of a content object, modification of a content object, etc.), the system may use the location of the input as the updated reference location. The system may update the reference location for each client device at a defined interval and/or in response to changes inputs for the client device. For example, as a user navigates to a new region of the virtual canvas, the system may detect the change in location of the viewport of the client device and update the reference location accordingly.

At operation 1006, the process 1000 can include determining that reference locations for client devices satisfy a clustering criteria at a region of a virtual canvas. The system may analyze the interrelation of each reference location with respect to other reference location and/or the interrelations of each reference location with respect to open or more content objects.

In some cases, the system may perform a first spatial grouping analysis for content objects that are added to the virtual canvas to identify set of object. For example, the system may perform a clustering analysis and a set of objects and/or define a region of the canvas corresponding to the defined set of objects. The system may then be able to analyze a reference location of each client device with respect to a set of graphical objects and/or the corresponding region.

Additionally or alternatively, the system may perform a second spatial grouping analysis to identify sets of client device that are interacting within a similar region of a virtual canvas. For example, the system may perform a clustering analysis to identify client devices with reference locations that are within a defined proximity to each other.

The system may be configured with cluster criteria that defines conditions for initiating a videoconference for a group of client devices that are interacting in a similar region of the virtual canvas and/or with a defined set of content objects. For example, a clustering criteria may define that at least the reference locations for two client devices are within a defined proximity to each other and that each reference location is also within a defined proximity to a content object (or determined set of content objects). This clustering criteria may be used to identify when two users are collaborating on a topic at a portion of the virtual canvas.

The clustering criteria may be defined in a variety of ways and take into account the proximity of content items added by various client device and the proximity of the reference locations for the client devices. In some cases, the clustering criteria may include a time component. For example, the clustering criteria may include that two reference locations have to be within a defined proximity to each other for a defined duration. Additionally or alternatively, the time component may require that one or more reference locations are within a defined proximity to a one or more content objects for a defined duration.

In some cases, the clustering criteria may include user account data. For example, the clustering criteria may be biased to identify client device as a set when the corresponding user accounts are assigned to a same issue (e.g., using data retrieved from the issue tracking system). In other cases, the clustering criteria may be biased to identify client devices as a set when the corresponding user accounts are assigned to a same team (e.g., based on receiving user account data from a user account platform), assigned to a same project and so on.

In other cases, the clustering criteria may take into account a current videoconference status of a user. For example, the clustering criteria may change if a client device is already participating in another videoconference. The clustering criteria may increase a time duration required to satisfy the criteria when a client device is participating in another videoconference, which may prevent unwanted prompts if the corresponding user is transiently navigating around the virtual canvas.

The system may determine independently identify different sets of reference locations that correspond to different regions of the virtual canvas and/or that are associated with different sets of content objects. For example, the system may determine that a first set of reference locations satisfy a clustering criteria at a first region of the virtual canvas (e.g., with respect to an identified first set of virtual content items). The system may also determine that a second set of reference location satisfy a clustering criteria at a second region of the virtual canvas. The system may interpedently and/or simultaneously determine that different sets of reference locations satisfy a clustering criteria for different regions of the virtual canvas.

The clustering criteria may include one or more factors, and each factor may be weighted differently depending on the particular implementation and/or based on current status of client devices and/or user accounts associated with a client device.

In response to determining that a set of reference locations satisfy a clustering criteria, the system may initiate a videoconference session for the corresponding client devices. For example, the system may send a request to the videoconferencing platform to cause each client device having a reference location stratifying the clustering criteria, display a prompt to join a videoconference.

The system may associate the video conference with a region of the virtual canvas. In some cases, the system may define the corresponding region based on a clustering analysis performed on content objects at that portion of the virtual canvas. For example, the system may define a region that includes all objects that are defined by a clustering analysis as belong to a particular set of objects. Additionally or alternatively, the system may define a region based on the viewports of client devices that have reference locations that satisfy the clustering criteria. For example, the system may define the region as an average viewport of the client devices that have reference locations that satisfy the clustering criteria.

At operation 1008, the process 1000 can include causing the client devices to display an interface comprising a videoconference portion and a virtual whiteboard portion. In response to initiating a video conference session with multiple client devices, the system may cause each client device to display an interface that includes the videoconference interface and the virtual whiteboard GUI. In some cases, the system may cause the whiteboard GUI to display the region that is associated with the video conference. Accordingly, in some cases, as the users enter a video conference, their corresponding client device may each display a same region of the virtual canvas.

FIG. 11 shows a sample electrical block diagram of an electronic device 1100 that may perform the operations described herein. The electronic device 1100 may in some cases take the form of any of the electronic devices described with reference to FIGS. 1-10, including client devices, and/or servers or other computing devices associated with the content collaboration system 100. The electronic device 1100 can include one or more of a processing unit 1102, a memory 1104 or storage device, input devices 1106, a display 1108, output devices 1110, and a power source 1112. In some cases, various implementations of the electronic device 1100 may lack some or all of these components and/or include additional or alternative components.

The processing unit 1102 can control some or all of the operations of the electronic device 1100. The processing unit 1102 can communicate, either directly or indirectly, with some or all of the components of the electronic device 1100. For example, a system bus or other communication mechanism 1114 can provide communication between the processing unit 1102, the power source 1112, the memory 1104, the input device(s) 1106, and the output device(s) 1110.

The processing unit 1102 can be implemented as any electronic device capable of processing, receiving, or transmitting data or instructions. For example, the processing unit 1102 can be a microprocessor, a processor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 1100 can be controlled by multiple processing units. For example, select components of the electronic device 1100 (e.g., an input device 1106) may be controlled by a first processing unit and other components of the electronic device 1100 (e.g., the display 1108) may be controlled by a second processing unit, where the first and second processing units may or may not be in communication with each other.

The power source 1112 can be implemented with any device capable of providing energy to the electronic device 1100. For example, the power source 1112 may be one or more batteries or rechargeable batteries. Additionally, or alternatively, the power source 1112 can be a power connector or power cord that connects the electronic device 1100 to another power source, such as a wall outlet.

The memory 1104 can store electronic data that can be used by the electronic device 1100. For example, the memory 1104 can store electronic data or content such as, for example, audio and video files, documents and applications, device settings and user preferences, timing signals, control signals, and data structures or databases. The memory 1104 can be configured as any type of memory. By way of example only, the memory 1104 can be implemented as random access memory, read-only memory, Flash memory, removable memory, other types of storage elements, or combinations of such devices.

In various embodiments, the display 1108 provides a graphical output, for example associated with an operating system, user interface, and/or applications of the electronic device 1100 (e.g., a chat user interface, an issue-tracking user interface, an issue-discovery user interface, etc.). In one embodiment, the display 1108 includes one or more sensors and is configured as a touch-sensitive (e.g., single-touch, multi-touch) and/or force-sensitive display to receive inputs from a user. For example, the display 1108 may be integrated with a touch sensor (e.g., a capacitive touch sensor) and/or a force sensor to provide a touch- and/or force-sensitive display. The display 1108 is operably coupled to the processing unit 1102 of the electronic device 1100.

The display 1108 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 1108 is positioned beneath and viewable through a cover that forms at least a portion of an enclosure of the electronic device 1100.

In various embodiments, the input devices 1106 may include any suitable components for detecting inputs. Examples of input devices 1106 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 1106 may be configured to detect one or more particular types of input and provide a signal (e.g., an input signal) corresponding to the detected input. The signal may be provided, for example, to the processing unit 1102.

As discussed above, in some cases, the input device(s) 1106 include a touch sensor (e.g., a capacitive touch sensor) integrated with the display 1108 to provide a touch-sensitive display. Similarly, in some cases, the input device(s) 1106 include a force sensor (e.g., a capacitive force sensor) integrated with the display 1108 to provide a force-sensitive display.

The output devices 1110 may include any suitable components for providing outputs. Examples of output devices 1110 include light emitters, audio output devices (e.g., speakers), visual output devices (e.g., lights or displays), tactile output devices (e.g., haptic output devices), communication devices (e.g., wired, or wireless communication devices), and so on, or some combination thereof. Each output device 1110 may be configured to receive one or more signals (e.g., an output signal provided by the processing unit 1102) and provide an output corresponding to the signal.

In some cases, input devices 1106 and output devices 1110 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 1102 may be operably coupled to the input devices 1106 and the output devices 1110. The processing unit 1102 may be adapted to exchange signals with the input devices 1106 and the output devices 1110. For example, the processing unit 1102 may receive an input signal from an input device 1106 that corresponds to an input detected by the input device 1106. The processing unit 1102 may interpret the received input signal to determine whether to provide and/or change one or more outputs in response to the input signal. The processing unit 1102 may then send an output signal to one or more of the output devices 1110, to provide and/or change outputs as appropriate.

While the foregoing discussion is directed to issue objects in the virtual whiteboard application corresponding to issues managed by the issue tracking system, the same principles apply to objects managed by any third-party system. For example, the same principles apply to content items managed by a content management system, mockup items managed by a user interface design system, or any other objects managed by any other third-party system. The virtual whiteboarding application may operate as described above to generate graphical elements corresponding to an object managed by a third-party system, accept user input for moving or modifying the graphical elements and thus the objects corresponding thereto, relate graphical elements and thus the objects corresponding thereto, and visualize relationships between objects.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the some embodiments of the invention, whether or not such embodiments are described, and whether or not such features are presented as being a part of a described embodiment. Thus, the breadth and scope of the present invention should not be limited by any of the above-described exemplary embodiments but is instead defined by the claims herein presented.

Furthermore, the foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, which are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed aggregated only for legitimate, agreed-upon, and reasonable uses.

What is claimed is:

1. A method for initiating multiple videoconference sessions using a virtual whiteboarding application, the method comprising:
causing display of a set of virtual whiteboard graphical user interfaces on multiple client devices, each client device associated with a respective user participating in a virtual whiteboarding session, each virtual whiteboard graphical user interface comprising a respective viewport to a virtual canvas, the virtual canvas configured to receive simultaneous user inputs from each of the multiple client devices;
determining a set of reference locations, the set of reference locations comprising a reference location for each respective viewport within the virtual canvas, each respective viewport corresponding to a respective portion of the virtual canvas displayed for a respective client device;
in response to determining that a first subset of the set of reference locations satisfy a cluster criteria, causing display of a first prompt on a first client device associated with a first reference location of the first subset of the set of reference locations, the first prompt including a first invitation to participate in a first videoconference having a first set of participants; and
in response to determining that a second subset of the set of reference locations satisfy the cluster criteria, causing display of a second prompt on a second client device associated with a second reference location of the second subset of the set of reference locations, the second prompt including a second invitation to participate in a second videoconference having a second set of participants different than the first set of participants.

2. The method of claim 1, further comprising:
identifying a first set of virtual objects within the virtual canvas;
identifying a second set of virtual objects within the virtual canvas;
determining the first subset of the set of reference locations satisfy the cluster criteria in response to determining that the reference location of a viewport for a corresponding client device satisfies a proximity condition with respect to the first set of virtual objects; and
determining the second subset of the set of reference locations satisfy the cluster criteria in response to determining that the reference location of a viewport for a corresponding client device satisfies the proximity condition with respect to the second set of virtual objects.

3. The method of claim 2, further comprising determining that the first subset of the set of reference locations satisfy the cluster criteria based on each corresponding client device satisfying the proximity condition for predetermined time duration.

4. The method of claim 1, further comprising determining the reference location for one or more of the multiple client devices in response to creation or modification of a virtual object within the virtual canvas, wherein the determined reference location is based on a location of the virtual object.

5. The method of claim 1, wherein the respective viewport associated with the respective client device is configured to be translated to a different portion of the virtual canvas in response to user input to a virtual whiteboard graphical user interface of the respective client device.

6. The method of claim 1, further comprising, in response to initiating the first videoconference having the first set of participants, causing a viewport for each client device of the first set of client devices to display a common reference location within the virtual canvas, wherein the common reference location is based on the first subset of the set of reference locations.

7. The method of claim 1, further comprising causing display in the virtual whiteboard graphical user interface on each client device participating in the virtual whiteboarding session, a set of location indicators indicating the reference location with other users with respect to the virtual canvas.

8. The method of claim 1, further comprising causing display in a respective virtual whiteboard graphical user interface of a respective client device participating in the virtual whiteboarding session, a set of videoconference indicators indicating active videoconference sessions occurring within the virtual whiteboarding session.

9. The method of claim 1, further comprising, in response to determining that the first reference location no longer satisfies the cluster criteria for the first subset of the set of reference locations, causing display of a second prompt on a first client device, the second prompt comprising an option to leave the first videoconference.

10. A method for managing videoconference sessions in a virtual whiteboarding application, the method comprising:
causing display of a virtual whiteboard graphical user interface on multiple client devices, each associated with a different user participating in a whiteboarding session, the virtual whiteboard graphical user interface comprising a virtual canvas configured to receive simultaneous inputs from the multiple client devices;
determining a reference location of a viewport within the virtual canvas, the viewport being displayed in the virtual whiteboard graphical user interface of a client device;
in response to determining that the reference location satisfies a proximity criteria corresponding a region of the virtual canvas associated with a videoconference, causing display of an option to join the videoconference on the client device; and
in response to receiving a selection of the option to join the videoconference, causing the client device to display a videoconference interface for the videoconference in a first area of the virtual whiteboard graphical user interface and the region of the virtual canvas in a second area of the graphical user interface.

11. The method of claim 10, further comprising causing display, within the virtual canvas, a first graphical element indicating that an active videoconference is associated with the region.

12. The method of claim 11, further comprising causing display, within the virtual canvas, a second graphical element indicating a set of users participating in the videoconference associated with the region.

13. The method of claim 12, wherein the second graphical element comprises one or more of: avatars of each user participating in the videoconference associated with the first region or a username of each user participating in the videoconference.

14. The method of claim 10, further comprising:
receiving from a user of the set of users participating in the videoconference, a first request for a particular user to join the videoconference; and
in response to receiving the first request, sending a second request to the client device associated with the particular user, the second request comprising an option to join the videoconference.

15. The method of claim 14, further comprising, in response to receiving a selection of the option to join the video conference from the client device associated with the particular user, causing the client device associated with the particular user to display a videoconference interface for the videoconference in a first area of the virtual whiteboard graphical user interface and the region of the virtual canvas in a second area of the graphical user interface.

16. A server system comprising:
a memory allocation defined by:
a data store storing one or more executable assets; and
a working memory allocation;
a processor allocation configured to load the one or more executable assets from the data store and into the working memory allocation to instantiate an instance of a client application on a client device, the one or more executable assets configured to:
cause display of a set of virtual whiteboard graphical user interfaces on multiple client devices, each client device associated with a respective user participating in a virtual whiteboarding session, each virtual whiteboard graphical user interface comprising a respective viewport to a virtual canvas, the virtual canvas configured to receive simultaneous user inputs from each of the multiple client devices;
determine a set of reference locations, the set of reference locations comprising a reference location for each client device of the multiple client devices, each reference location indicating a location of the respective viewport within the virtual canvas, the viewport being displayed in the virtual whiteboard graphical user interface for a corresponding client device; and
in response to determining that a first subset of the set of reference locations satisfies a cluster criteria, cause display of a first prompt on a first client device associated with a first reference location of the first subset of the set of reference locations, the first prompt including a first invitation to participate in a first videoconference having a first set of participants.

17. The server system of claim 16, wherein the processor allocation is further configured to, in response to determining that a second subset of the set of reference locations satisfies the cluster criteria, cause display of a second prompt on a second client device, the second prompt including a second invitation to participate in a second videoconference having a second set of participants different than the first set of participants.

18. The server system of claim 16, wherein the processor allocation is further configured to determine the reference location for one or more of the multiple client devices in response to creation or modification of a virtual object within the virtual canvas, wherein the determined reference location is based on a location of the virtual object.

19. The server system of claim 16, wherein the processor allocation is further configured to, in response to receiving a selection of the invitation to participate in the first videoconference, causing the first client device to display a videoconference interface for the videoconference in a first area of the virtual whiteboard graphical user interface and the region of the virtual canvas in a second area of the virtual whiteboard graphical user interface.

20. The server system of claim 19, where in the processor allocation is further configured to cause display, within the virtual canvas, a first graphical element indicating that an active videoconference is associated with the region.
